(19) United States
(12) Patent Application Publication
(10) Pub. No.: US 2009/0242674 A1
(43) Pub. Date: Oct. 1, 2009

(54) MOBILE WASTE DISPOSAL SYSTEM

(75) Inventors: Yong Bok LEE, Seoul (KR); Choong Hyun KIM, Seoul (KR); Chang Ho KIM, Seoul (KR)

Correspondence Address: BACON & THOMAS, PLLC, 625 SLATERS LANE, FOURTH FLOOR, ALEXANDRIA, VA, 22314-1176, US

(73) Assignee: KOREA INSTITUTE OF SCIENCE AND TECHNOLOGY, Seoul (KR)

(21) Appl. No.: 12/411,766

(22) Filed: Mar. 26, 2009

(30) Foreign Application Priority Data
Mar. 27, 2008 (KR) 10-2008-0028281

(51) Int. Cl. B02C 21/00

(52) U.S. Cl. 241/65

(57) ABSTRACT

A waste disposal system includes a pulverizing tank where wastes are put into; a pulverizing device for pulverizing the wastes and making them into slurry; one or more heat and dry tanks connected to the pulverizing tank for drying and heating the slurry; a heating device for heating the heat and dry tank; and a vapor discharge device for discharging vapors generated by the heat and dry process of the slurry. The waste disposal system further includes a slurry drain unit for discharging the heated and dried slurry.

### FIELD OF THE INVENTION

The present invention relates to a waste disposal system and, more particularly, to a mobile waste disposal system with high efficiency capable of being mounted to a vehicle so that the system can be rapidly moved to a site where large amount of dead poultry infected with contagious disease is created, and then dispose the dead poultry in a short period of time.

### BACKGROUND OF THE INVENTION

In general, mass die-off of poultry such as chicken, duck, and goose frequently occurs due to contagious diseases or poor raising conditions. Such dead poultry is buried to prevent spread of the contagious diseases.

However, such burial method produces leachate contaminated with infectious bacteria in the dead poultry or decomposed poultry and thus the contaminated materials in the leachate are transferred to soil, groundwater, and air to cause spread of various contagious diseases.

Meanwhile, there are proposed a medical waste disposal apparatus and a medical waste sterilizing apparatus in Korean Utility Model Publication No. 2000-0000343 and Korean Patent Registration No. 10-0287075, respectively, in which the waste is pulverized by a rotating drum driven by electric motor and blades arranged at inner wall of the drum, sterilized by heating device, contracted by piston, and discharged.

Further, a drying apparatus mounted to vehicle for disposing food wastes is proposed in Korean Patent Publication No. 1998-56356, in which the food wastes are pulverized with low speed pulverizing roll and then dried by making a barrel containing the pulverized wastes to be vacuum state.

Above described prior arts have low efficiency in pulverizing the food wastes, and are not suitable for disposing body tissues and body fluid of the dead poultry.

Moreover, it is known, by Y. C. Jang et al., 2006 “Medical Waste Management in Korea”, J. of Environment Management, Vol 80, PP 107-115, a study of creation, sorting, transferring, and processing of medical wastes and problems and solution thereof. The document discloses complex medical wastes disposal method containing plastic products as well as removed organs. However, the method is not suitable for the dead poultry of the body tissues and body fluid.

Therefore, there has been demand for a development of an apparatus for disposing the contagious dead poultry in a sanitary, rapid, and cost effective way.

### DISCLOSURE OF THE INVENTION

In view of the above-noted problems, it is an object of the present invention to provide a waste disposal system mountable to a vehicle capable of disposing the contagious dead poultry in a sanitary, rapid, and cost effective way. In accordance with an embodiment of the present invention, there is provided a waste disposal system including: a pulverizing tank where wastes are put into; a pulverizing device for pulverizing the wastes and making them into slurry; one or more heat and dry tanks connected to the pulverizing tank for drying and heating the slurry; a heating device for heating the heat and dry tank; a vapor discharge device for discharging vapors generated by the heat and dry process of the slurry; and a slurry drain unit for discharging the heated and dried slurry.

The waste disposal system in accordance with the present invention is mobile waste disposal system capable of being mounted to a vehicle so that the system can be rapidly moved to a site where dead poultry is created, and then processes the dead poultry, thereby preventing spread of contagious diseases due to improper disposing of the contagious dead poultry. Further, a hydraulic device driven by an engine of a vehicle is employed without extra power source, and therefore, it is possible to manufacture simply. Furthermore, the system has high efficiency in pulverizing the dead poultry by using rapidly rotating pulverizing blades.

Moreover, the waste disposal system in accordance with the present invention sterilizes the pulverized dead poultry by using hot heating device so as to change the contagious dead poultry infected with Avian Influenza (AI) to safe general wastes, while largely reducing final quantity of the wastes, thereby highly reducing the disposal cost.

### BRIEF DESCRIPTION OF THE DRAWINGS

The above and other objects and features of the present invention will become apparent from the following description of embodiments given in conjunction with the accompanying drawings, in which:

FIG. 1 illustrates the configuration of a waste disposal system in accordance with an embodiment of the present invention.

### DETAILED DESCRIPTION OF THE EMBODIMENTS

Embodiments of the present invention will now be described with reference to accompanying drawings which form a part hereof.

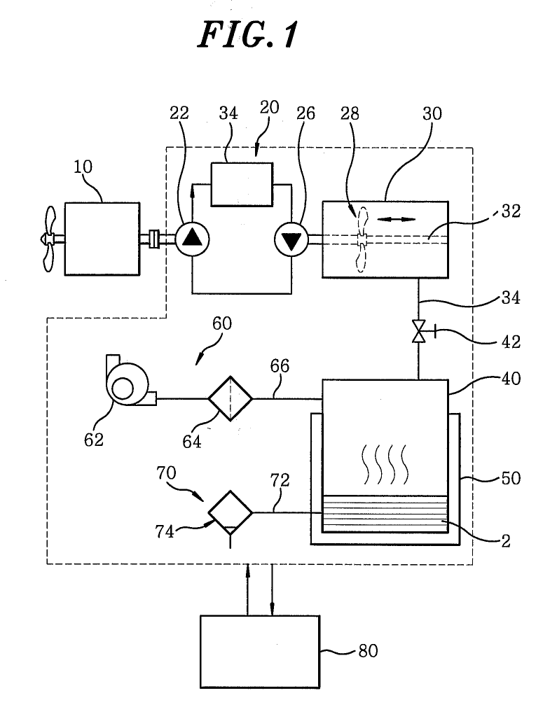

FIG. 1 illustrates the configuration of a waste disposal system in accordance with an embodiment of the present invention. As shown in the drawing, the waste disposal system of the present invention includes a pulverizing tank 30 for containing wastes such as dead poultry; a pulverizing device 20 for pulverizing the wastes in the pulverizing tank 30 into a slurry 2; a heat and dry tank 40 connected to the pulverizing tank 30 to heat and dry the slurry 2 in the pulverizing tank 30; a heating device 50 for heating the heat and dry tank 40; a vapor discharge device 60 for discharging the vapor generated by heating and drying the slurry 2; a drain unit 70 for discharging the heated and dried slurry 2; and a control unit 80 for controlling the operation of the waste disposal system. The waste disposal system may be mounted to a vehicle.

The pulverizing device 20 includes a power source 10; an oil tank 24 for containing oil; a hydraulic pump 22 driven by the power source 10; a hydraulic motor 26 operable by a hydraulic pressure acting on the oil in the oil tank 24 by the hydraulic pump 22, and pulverizing blades 28 connected to the hydraulic motor 26 through a rotation shaft 32 and arranged in the pulverizing tank 30. However, the power source 10 may include an engine of a vehicle on which the disposing system is mounted. In this case, the hydraulic pump 22 is connected to the engine of the vehicle by using known method. The rotation shaft 32 is configured to move in a lengthwise direction of the pulverizing tank 30. Accordingly, the pulverizing blades 28 are movable in the lengthwise directions while pulverizing the dead poultry contained in the pulverizing tank 30. It is also possible to configure the rotation shaft 32 not to move in the lengthwise directions so that the pulverizing blades are not movable in the lengthwise directions while pulverizing the dead poultry.

It is preferable that the pulverizing tank 30 further includes an agitating device (not shown) arranged at an inner wall thereof or other places inside thereof. Further, it is also possible that the pulverizing tank 30 is configured to rotate itself to increase pulverizing efficiency. Moreover, the system may further include waste supply device to the pulverizing thank 30 to supply the waste sequentially in a predefined amount.

The slurry 2 pulverized in the pulverizing tank 30 is transferred to the heat and dry tank 40 through transfer pipe 34. A hydraulic pump (not shown) and a valve 42 installed in the transfer pipe 34 control the amount of the slurry 2 being transferred.

The slurry 2 transferred to the heat and dry tank 40 is heated to about 75° C. or more by the heating device 50 and then sterilized. The heat and dry tank 40 is insulated with insulation material to increase heating and drying efficiency. The heating device 50 may use any one of heating sources using electricity, fossil fuel, chemical material, hot water, hot steam, and hot oil. The heating device 50 can be installed both of inside or outside the heat and dry tank 40. It is preferable to install the heating device 50 inside and outside the heat and dry tank 40 considering heating and drying efficiency.

Predetermined amounts of burnt lime, charcoal powder, clay, sawdust, shredded paper, or yeast may be put into the heat and dry tank 40 to increase heating and drying efficiency. One or more the heat and dry tanks 40 may be connected to the pulverizing thank 30 in parallel or serial.

The heat and dry tank 40 are provided with a vapor discharge pipe 66, a blower 62 installed in the vapor discharge pipe 66, and a vapor discharge unit 60 having a sterilizing filer 64. The heat and dry tank 40 are further provided with a slurry drain unit 70 having a drain pipe 72 and a drain discharger 74 installed in the drain pipe 72.

Hereinafter, the operation of the waste disposing system in accordance with the present invention as configured above will be described.

When there occurs contagious wastes such as dead bodies of poultry, the waste disposal system being mounted to a vehicle can be rapidly moved to a spot where the wastes are located. Thereafter, the hydraulic pump 22 driven by a power from the engine of the vehicle compresses the oil in the oil tank 30 and the hydraulic motor 26 is rotated by the compressed oil. Accordingly, the pulverizing blades 28 connected to the hydraulic motor 26 rotate rapidly.

Since the rotating blades 28 are arranged in the rotation shaft 32 installed in the lengthwise direction of the pulverizing tank 30 into which the wastes are provided, and are movable in the lengthwise directions, the blades 28 rotating rapidly can finely pulverize the wastes. The pulverized wastes then become the slurry 2 mixed with body tissues such as muscles and bonds of the dead poultry and various body fluids such as blood. Thereafter, the mixed slurry 2 is transferred to the heat and dry tank 40 through the transfer pipe 34 having the hydraulic pump (not shown) and the valve 42.

The heat and dry tank 40 is heated in high temperature by the heating device 50 installed inside and/or outside thereof. Accordingly, the transferred slurry 2 is dried while the water evaporates and sterilized at high temperature. It is known that the infection from the Avian Influenza virus, occurred in many countries and causing global concern, could be stopped when an infected source is heated up to 75° C.

As the heat and dry tank 40 is heated by the heating device 50, vapor is generated from the heated slurry 2 in the heat and dry tank 40, which contains various bacteria and contaminated particles. The various bacteria and contaminated particles are filtered and discharged outside the heat and dry tank 40 by the blower 62 and the sterilizing filter 64 installed in the vapor discharge pipe 66 of the vapor discharge device 60.

A residue of the dried slurry 2 in the heat and dry tank 40 is discharged outside the heat and dry tank 40 by the drain unit 70 and disposed in a waste back as like normal disposing process of normal wastes.

The waste disposal system in accordance with the present invention sterilizes the pulverized dead poultry at high temperature so as to be transformed into normal wastes without danger of infection, while highly reducing the cost of the disposal due to drying process.

While the invention has been shown and described with respect to the embodiments, it will be understood by those skilled in the art that various changes and modifications may be made without departing from the scope of the invention as defined in the following claims.

What is claimed is:

1. A waste disposal system, comprising:
a pulverizing tank where wastes are put into;
a pulverizing device for pulverizing the wastes and making them into slurry;
one or more heat and dry tanks connected to the pulverizing tank for drying and heating the slurry;
a heating device for heating the heat and dry tank;
a vapor discharge device for discharging vapors generated by the heat and dry process of the slurry; and
a slurry drain unit for discharging the heated and dried slurry.

2. The waste disposal system of claim 1, wherein the pulverizing device comprises:
a power source;
an oil tank for storing oil;
a hydraulic pump driven by the power source;
a hydraulic motor operable by the compressed oil in the oil tank by the hydraulic pump; and
pulverizing blades installed in the pulverizing tank and connected to the hydraulic motor through a shaft.

3. The waste disposal system of claim 2, wherein the pulverizing blades are movable in lengthwise directions of the pulverizing tank.

4. The waste disposal system of claim 1, further comprising an agitating device at an inner wall of the pulverizing tank or inside the pulverizing tank.

5. The waste disposal system of claim 1, wherein the pulverizing tank is configured to rotate.

6. The waste disposal system of claim 1, wherein the pulverizing tank includes a waste supply device for supplying predetermined amount of the wastes sequentially.

7. The waste disposal system of claim 1, wherein the slurry is sterilized in the heat and dry tank by heating the slurry at high temperature.

8. The waste disposal system of claim 1, wherein the heat and dry tank has an insulator thermally insulated outer surface thereof.

9. The waste disposal system of claim 1, wherein the heating device obtains heating source using any one of electricity, fossil fuel, chemical material, hot water, hot steam, and hot oil.

10. The waste disposal system of claim 1, wherein the heating device is installed inside and outside the heat and dry tank.

11. The waste disposal system of claim 1, wherein the heat and dry tank is put with any one of burnt lime, charcoal powder, clay, sawdust, shredded paper, and yeast, or combination thereof.

12. The waste disposal system of claim 1, wherein the one or more of the heat and dry tanks are connected to the pulverizing tank in parallel or serial.

13. The waste disposal system of claim 2, wherein the system is mountable to a vehicle power source is an engine of a vehicle.

14. The waste disposal system of claim 13, wherein the power source is an engine of the vehicle.

15. The waste disposal system of claim 1, wherein the vapor discharge device includes sterilizing filter.
